(19) United States
(12) Patent Application Publication
(10) Pub. No.: US 2008/0083213 A1
(43) Pub. Date: Apr. 10, 2008

(54) HC trap catalyst and preparation method for HC trap catalyst

(75) Inventors: Hiroshi Tanada, Nagoya-shi (JP); Mayuko Suwa, Okazaki-shi (JP); Tatsuya Okubo, Tokyo (JP); Masaru Ogura, Tokyo (JP); Shanmugam P. Elangovan, Tokyo (JP)

Correspondence Address: BIRCH STEWART KOLASCH & BIRCH, PO BOX 747, FALLS CHURCH, VA, 22040-0747, US

(73) Assignees: Mitsubishi Jidosha Kogyo Kabushiki Kaisha, Tokyo (JP); THE UNIVERSITY OF TOKYO, Tokyo (JP)

(21) Appl. No.: 11/902,355

(22) Filed: Sep. 20, 2007

(30) Foreign Application Priority Data
Sep. 22, 2006 (JP) 2006-256562

(51) Int. Cl. F01N 3/10; B01J 29/064

(52) U.S. Cl. 60/297; 423/213.2; 502/66

(57) ABSTRACT

The invention relates to an HC trap catalyst and a preparation method for the HC trap catalyst. The HC trap catalyst includes an HC adsorbent for adsorbing HC in exhaust gas exhausted from an internal combustion engine, and an oxidation accelerating element contained in the HC adsorbent for accelerating partial oxidation of the HC adsorbed by the HC adsorbent. With the above configuration, HC in exhaust gas can be partially oxidized. As a result, the oxidation reactivity of HC can be improved remarkably. Further, since the oxidation accelerating element is contained in the HC adsorbent, the HC adsorbed in the HC adsorbent can be partially oxidized directly. As a result, the partial oxidation can be promoted efficiently.

### CROSS-REFERENCE TO THE RELATED APPLICATION

This application incorporates by references the subject matter of Application No. 2006-256562 filed in Japan on Sep. 22, 2006 on which a priority claim is based under 35 U.S.C. §119(a).

### BACKGROUND OF THE INVENTION

1) Field of the Invention

The present invention relates to an HC trap catalyst for adsorbing HC in exhaust gas exhausted from an internal combustion engine to purify the exhaust gas and a preparation method for the HC trap catalyst.

2) Description of the Related Art

Conventionally, a catalyst having a function of adsorbing HC (Hydrocarbon; unburned fuel component) in an exhaust gas exhausted from an internal combustion engine of an automobile to purify the exhaust gas is provided on a path of the exhaust gas. For example, a three way catalyst which carries a noble metal component such as platinum (Pt), palladium (Pd) or rhodium (Rh) and includes activated alumina as a principal component has a function of simultaneously decomposing and removing HC, carbon monoxide (CO) and nitrogen oxides (NOx) included in the exhaust gas making use of oxidation-reduction reaction.

The reactivity in such oxidation-reduction on the catalyst depends upon the temperature of the catalyst itself, the exhaust gas temperature and so forth, and the oxidation efficiency of HC normally drops in a low temperature condition. Therefore, techniques have been developed which additionally use an adsorbent having a function of temporarily adsorbing substances which relate to the oxidation-reduction reaction thereby to enhance the reactivity in oxidation-reduction.

One of such techniques is disclosed, for example, in Japanese Patent Application Laid-Open No. 2003-343316. In particular, the document discloses a configuration wherein an HC trap catalyst which adsorbs HC in a low temperature condition is interposed in an exhaust path together with a three way catalyst. The HC trap catalyst adsorbs HC in a low temperature condition and desorbs the adsorbed HC as the temperature rises. Through the use of such an adsorbent as described above, the discharge amount of HC to the outside in a state wherein the temperature of the three ways catalyst remains low and is not in an activated state like immediately after an engine is started can be reduced.

It is to be noted that various types of zeolite are generally used as the adsorbent for HC. Zeolite is a general term of crystalline porous bodies (synthetic silicates) having a three-dimensional network structure wherein a large number of atoms of silicon (silica; Si) and aluminum (Al) are bonded to each other through oxygen (O) atoms. The three-dimensional structure of the zeolite has basic units of two regions (SiO₄)⁴⁻ and (AlO₄)⁵⁻ having a tetrahedral structure. Such basic units have a molecular structure wherein an oxygen atom is positioned at each vertex and a silicon or aluminum atom is arranged in the inside of the basic units. Adjacent tetrahedrons are bonded to each other such that they share the oxygen atoms at the vertices and form a crystal structure. Further, the crystal structure may have various shapes, which are classified into similar types such as the FER type, MOR type, FAU type, MFI type and β type.

Incidentally, where attention is paid to the adsorbing-desorbing performance for HC of the adsorbent, HC is desorbed not necessarily only in a temperature region in which the oxidation reactivity on the catalyst is high, but desorption of HC is observed a little also in a low temperature region.

For example, in FIG. 15, a detection result of the concentration of HC discharged to the outside of an exhaust path where only zeolite as an HC adsorbent is interposed on the exhaust path is indicated by a solid line, and a detection result of the concentration of HC where an oxidation catalyst for HC is interposed on the downstream side of zeolite is indicated by a broken line in the form of a graph. It is to be noted that, in the graph of FIG. 15, the axis of abscissa indicates the temperature of the catalyst carrying zeolite, and the axis of ordinate indicates the concentration of HC.

As seen from FIG. 15, in a temperature region higher than approximately 150° C., the HC concentration is suppressed low by interposition of an oxidation catalyst. In other words, in a high temperature condition, the oxidation catalyst functions effectively.

However, in a temperature region lower than approximately 150° C., even if an oxidation catalyst for HC is interposed on the downstream of zeolite, no change is found in the detection result of the HC concentration. Because the oxygen activation of the oxidation catalyst is insufficient, HC desorbed from the HC adsorbent is discharged to the outside of the exhaust path while it remains in a non-oxidized state. In this manner, in a low temperature condition, a sufficient function of the oxidation catalyst cannot be expected and the amount of HC to be discharged to the outside cannot be reduced.

A technique for enhancing the reactivity of HC on such an oxidation catalyst as described above is disclosed, for example, in Japanese Patent Application Laid-Open No. 2005-319368. The document discloses an exhaust gas purification apparatus for an internal combustion engine having a configuration which includes a hydrocarbon conversion catalyst for converting the molecular shape of HC. According to the technique, the exhaust gas purification apparatus is configured such that zeolite which carries cerium (Ce) or silver (Ag) is used as the hydrocarbon conversion catalyst. Further, the technique uses a configuration which converts part of paraffinic hydrocarbon (CnH₂ₙ₊₂) included in exhaust gas into olefinic hydrocarbon (CₙH₂ₙ) or aromatic hydrocarbon. By the configurations, dropping of the purification temperature on the oxidation catalyst (that is, the temperature necessary for an oxidation reaction of HC) can be achieved, and the HC purification effect in exhaust gas in a low temperature condition is enhanced.

However, dropping of the purification temperature of the oxidation catalyst naturally has a limit. It is actually difficult to raise the oxidation reactivity of the oxidation catalyst in all temperature regions in which HC can be desorbed from the adsorbent.

### SUMMARY OF THE INVENTION

It is an object of the present invention to provide an HC trap catalyst and a preparation method for an HC trap catalyst wherein HC in exhaust gas is modified to raise the reactivity so that the oxidation reactivity on an oxidation catalyst can be enhanced.

(1) The inventors of the present invention found that, if HC contained in exhaust gas is partially oxidized, then the oxidation reactivity of the partially oxidized HC on the oxidation catalyst improves remarkably.

Accordingly, according to an aspect of the present invention (claim 1), there is provided an HC trap catalyst comprising an HC adsorbent for adsorbing HC in exhaust gas exhausted from an internal combustion engine, and an oxidation accelerating element contained in the HC adsorbent for accelerating partial oxidation of the HC adsorbed by the HC adsorbent.

With the HC trap catalyst, HC in exhaust gas can be partially oxidized. As a result, the oxidation reactivity of HC can be improved remarkably. Further, since the oxidation accelerating element is contained in the HC adsorbent, the HC adsorbed in the HC adsorbent can be partially oxidized directly. As a result, the partial oxidation can be promoted efficiently.

(2) The HC trap catalyst of the present invention (claim 2) may be configured such that the HC adsorbent comprises zeolite, which is a crystalline porous body having a three-dimensional network structure.

With the HC trap catalyst, the oxidization reactivity of HC can be raised readily at a low cost by applying zeolite which is a general adsorbent for HC.

(10) According to another aspect of the present invention (claim 10), there is provided a preparation method for an HC trap catalyst which utilizes a solid phase method of an HC trap catalyst interposed in an exhaust path of an internal combustion engine, comprising a first step of producing nanomatrix of a metal species and silica to synthesize a mesoporous substance, a second step of baking the mesoporous substance synthesized by the first step to increase the surface area of the porous substance, a third step of preparing a composite material of the substance obtained by the second step and a zeolite crystallizer, and a fourth step of crystallizing the composite material prepared by the third step.

With the preparation method for an HC trap catalyst, zeolite beta having both of micropores and mesopores can be produced. Further, it is possible to contain a transition metal readily into the skeleton of the zeolite beta.

### BRIEF DESCRIPTION OF THE DRAWINGS

The above and other objects, features and advantages of the present invention will become apparent from the following description and the appended claims, taken in conjunction with the accompanying drawings in which like parts or elements are denoted by like reference characters.

FIG. 1 is a schematic molecular structure diagram showing a skeletal structure of zeolite beta in an HC trap catalyst according to an embodiment of the present invention;

FIG. 2 is a schematic sectional view of the HC trap catalyst according to the embodiment of the present invention;

FIG. 3 is a schematic view showing a general configuration of an internal combustion engine which includes the HC trap catalyst according to the embodiment of the present invention;

FIG. 4 shows a chromatogram obtained by a confirmation experiment of a partial oxidizing power of the HC trap catalyst according to the embodiment of the present invention;

FIG. 5(a) is a graph illustrating an adsorption/desorption characteristic of HC by metals contained in the HC trap catalyst according to the embodiment of the present invention and particularly illustrating an adsorption/desorption characteristic of HC where various transition metals are contained in zeolite beta;

FIG. 5(b) is a graph illustrating an adsorption/desorption characteristic of HC by metals contained in the HC trap catalyst according to the embodiment of the present invention and particularly illustrating an adsorption/desorption characteristic of HC after the materials used in the experiment illustrated in FIG. 5(a) are hydrothermally processed;

FIG. 6 is a flow chart illustrating a preparation method for zeolite beta in the HC trap catalyst according to the embodiment of the present invention;

FIG. 7 is a graph illustrating an nitrogen adsorption/desorption isotherm of zeolite beta in the HC trap catalyst according to the embodiment of the present invention;

FIG. 8 is a graph illustrating a result of a partial oxidizing power analysis by the HC trap catalyst according to the embodiment of the present invention;

FIG. 9 is a graph illustrating an oxidation reactivity of HC partially oxidized by the HC trap catalyst according to the embodiment of the present invention;

FIG. 10b(a) is a graph illustrating an oxidation reactivity of HC cracked from trimethylpentane (2.2.4-TMP) into butene by the HC trap catalyst with platinum according to the embodiment of the present invention;

FIG. 10(b) is a graph illustrating an oxidation reactivity of HC cracked by the HC trap catalyst according to the embodiment of the present invention and particularly illustrating an oxidation reactivity where a palladium catalyst is used;

FIG. 11 is a graph illustrating a desorption preventing power of HC by the zeolite beta of the HC trap catalyst according to the embodiment of the present invention;

FIG. 12 is a schematic molecular structure diagram illustrating a skeletal structure of zeolite beta of an HC trap catalyst as a modification of the present invention;

FIG. 13 is a graph illustrating the desorption amount of toluene from the zeolite beta of the HC trap catalyst as the modification of the present invention and particularly illustrating the desorption amount from zeolite beta obtained by solid phase synthesis and the adsorption amount from zeolite beta obtained by an ion exchange method;

FIG. 14(a) is a graph illustrating characteristics of various types of zeolite used as a material for the HC trap catalyst according to the modification of the present invention and particularly illustrating the adsorption performance of HC;

FIG. 14(b) is a graph illustrating characteristics of various types of zeolite used as a material for the HC trap catalyst according to the modification of the present invention and particularly illustrating the desorption performance of HC; and

FIG. 15 is a graph illustrating HC emitting amount characteristics from an HC adsorbent according to the prior art and an HC adsorbent which contains an oxidation catalyst and particularly illustrating a correspondence relationship between the temperature of a catalyst which carries zeolite as an HC adsorbent and the HC emission amount.

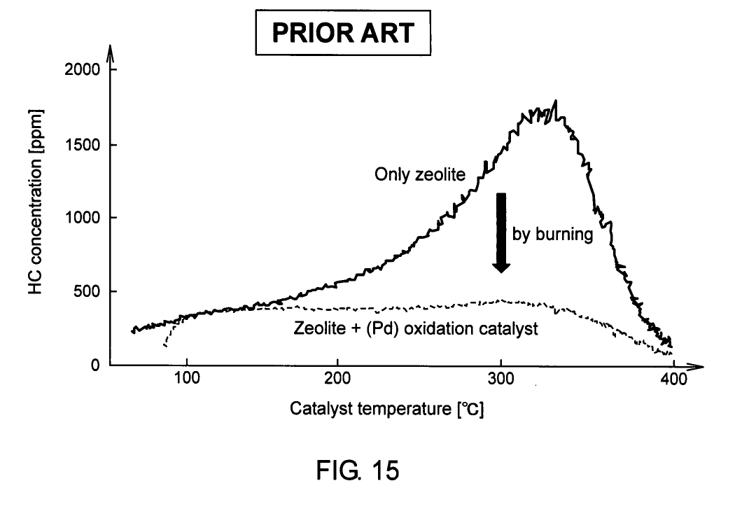

### DESCRIPTION OF THE PREFERRED EMBODIMENT

[General Configuration]

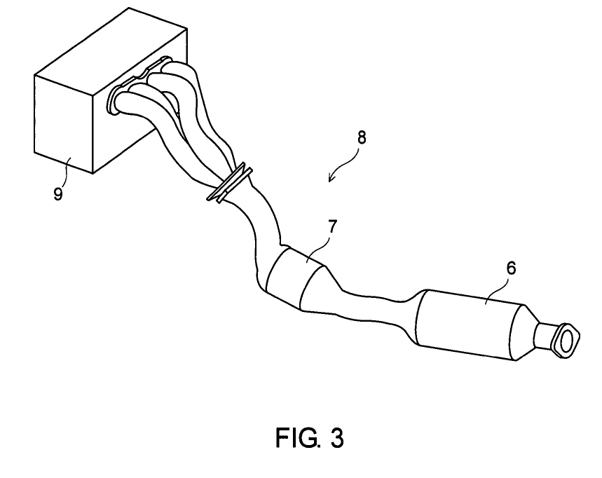

Referring first to FIG. 3, there is shown a general configuration of an internal combustion engine which includes an HC trap catalyst according to the present invention. The present system includes a three way catalyst 7 arranged immediately below a collecting portion of an exhaust manifold of a straight type four-cylinder engine 9 carried on a vehicle, and an HC trap catalyst 6 arranged on the downstream side of an exhaust path 8.

The three way catalyst 7 is a catalyst of the type which utilizes oxidation and reduction reactions to decompose and remove HC, carbon monoxide and nitrogen oxides included in exhaust gas at a time. Meanwhile, the HC trap catalyst 6 is a catalyst of the type which adsorbs HC contained in exhaust gas and decomposes and removes the HC.

The three way catalyst 7 is arranged at a position proximate to the engine 9 so that the temperature of the three way catalyst 7 can be raised early. Further, the HC trap catalyst 6 is arranged on the downstream side of the three way catalyst 7 so that HC flowing to the downstream of the three way catalyst 7 before the three way catalyst 7 is activated can be adsorbed and removed by the HC trap catalyst 6.

[Configuration of the HC Trap Catalyst]

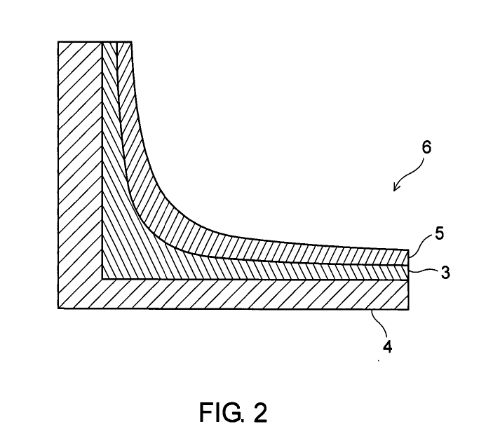

A sectional shape of the HC trap catalyst 6 is shown in FIG. 2. Referring to FIG. 2, the HC trap catalyst 6 includes an HC adsorbent layer 3 and a three-way catalyst layer (oxidation catalyst material layer) 5 both coated in layers on the surface of a carrier 4 formed by partitioning the cross section of the path. The HC trap catalyst 6 is produced such that, as the coating amount of the layers, the HC adsorbent layer 3 has a coating amount of 50 g/L to 200 g/L and the oxidation catalyst material layer 5 has a coating amount of 50 g/L to 200 g/L.

The HC adsorbent layer 3 is formed from zeolite beta (HC adsorbent) having mesopores and contains a metal element (oxidation accelerating element) which is at least one of iron (Fe), manganese (Mn) and cobalt (Co). The zeolite beta is also called beta zeolite or β-type zeolite and is a kind of zeolite which has 12-membered oxygen ring pores. Further, the ring structure formed from 12 oxygen atoms forms a micropore (hole smaller than 2 nm). It is to be noted that a general production method of zeolite beta is disclosed, for example, in U.S. Pat. No. 3,308,069, U.S. Pat. No. 4,642,226, Japanese Patent Application Laid-Open No. Hei 5-201722, Japanese Patent Application Laid-Open No. Hei 6-91174 and Japanese translation of PCT international application No. Hei 8-509452.

The HC adsorbent layer 3 according to the present invention has not only micropores but also mesopores having a diameter of approximately 2 to 50 nm. In the present embodiment, zeolite beta having mesopores is synthesized from MCM-41 which is a kind of mesoporous silica. A preparation method of the zeolite beta is described later.

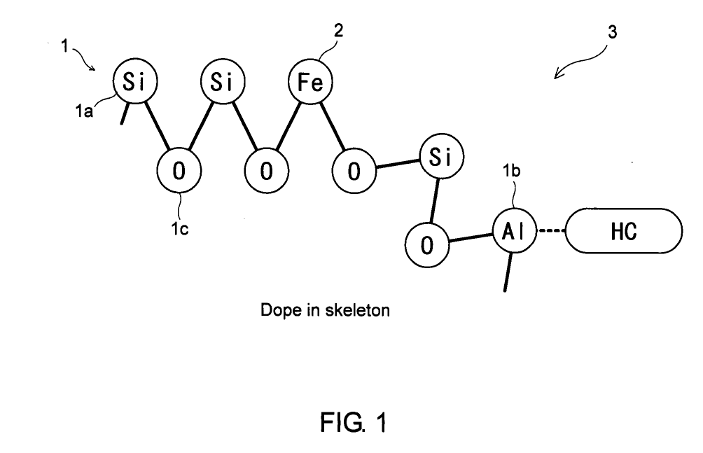

Further, the HC adsorbent layer 3 of the present embodiment has a molecular structure wherein silicon or aluminum which forms a skeletal structure of such zeolite beta as described above is replaced by a metal element selected from iron, manganese and cobalt mentioned hereinabove. The molecular structure which contains iron from among the aforementioned three different metal elements is schematically illustrated in FIG. 1.

As described hereinabove, the zeolite generally has a crystal structure produced from basic units of a three-dimensional tetrahedral structure composed of silicon, aluminum and oxygen. Meanwhile, in the zeolite beta 1 which forms the HC adsorbent layer 3, an atom of iron 2 is disposed at the position of silicon 1a or aluminum 1b which is to be disposed at the center of a tetrahedral structure as seen in FIG. 1. In other words, the iron 2 is doped and fixed in the skeleton of the zeolite beta 1, and the iron 2 is in a covalent bonded state with oxygen 1c similarly to the silicon 1a or the aluminum 1b. By such a molecular structure as just described, the HC adsorbent layer 3 adsorbs HC exhausted from the engine 9 and accelerates partial oxidation of the adsorbed HC.

The partial oxidation is not a complete oxidation reaction but a reaction by which HC is oxidized partially. For example, the partial oxidation is such a reaction as to oxidize toluene [benzene whose one hydrogen atom is replaced by a methyl group (CH₃)] into benzaldehyde [benzene whose one hydrogen atom is replaced by an aldehyde group (CHO)]. Such a partial oxidation phenomenon is expected to occur with olefin and long-chain paraffin.

It is to be noted that the partial oxidation power of HC by the HC adsorbent layer 3 can be confirmed using a known gas chromatography method or a like method. For example, the concentration of toluene and the concentration of benzaldehyde before and after the action of the HC adsorbent in exhaust gas are measured. If the concentration of benzaldehyde increases (or if the concentration of toluene decreases), then this signifies that the HC is partially oxidized by the HC adsorbent layer 3.

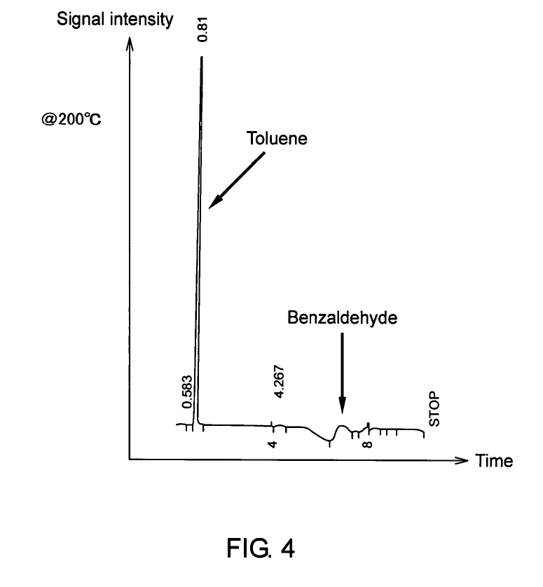

FIG. 4 illustrates a chromatogram obtained when a confirmation experiment was conducted. This is a result of the measurement of substances included in HC based on the concentration of HC after the action of the HC adsorbent in exhaust gas of 200° C. FIG. 4 indicates the fact that not only toluene but benzaldehyde existed in the exhaust gas.

The atom number ratio between the silicon 1a and the aluminum 1b in the HC adsorbent layer 3 is within the range of [Si]/[Al]=10 to 100, preferably the range of 10 to 30. Meanwhile, the atom number ratio between the silicon 1a and the iron 2 is the range of [Si]/[Fe]=10 to 100, preferably the range of 20 to 50.

Further, it has become clear that, in the present HC adsorbent layer 3, cracking (catalytic cracking; contact decomposition) occurs with HC adsorbed by the HC adsorbent layer 3 by an action of the iron or aluminum in the skeleton included in the zeolite beta 1 or by behavior of the skeleton acidic property. Also with regard to this, a known gas chromatography method can be used to measure the concentration of isooctane [2.2.4-TMP, CH₃C(CH₃)₂CH₂CH(CH₃)₂] and the concentration of butene (C₄H₈) before and after the action of the HC adsorbent in exhaust gas. The contact decomposition property of HC by the HC adsorbent layer 3 can be confirmed from a rise of the concentration of butene (or from a fall of the concentration of isooctane).

It is to be noted that the oxidation catalyst material layer 5 is formed from a known oxidation catalyst (for example, Pt—Al₂O₃), which contains a noble metal such as platinum, palladium or rhodium and can oxidize and burn HC.

[Reason of Selection of Iron, Manganese and Cobalt]

The transition metal such as iron, manganese or cobalt in the HC adsorbent layer 3 of the present embodiment has two roles. The first role is to partially oxidize HC adsorbed by the HC adsorbent layer 3 or HC desorbed from the HC adsorbent layer 3, and the second role is to crack HC.

It is generally known that a transition metal exhibits activity on oxidation of HC. The inventors of the present invention have found that zeolite which contains the transition metals exhibit an oxidation accelerating property of HC. Especially, zeolite which contains iron, manganese, nickel (Ni) or silver (Ag) exhibit a high oxidation accelerating property. It was found that, among the metals mentioned, iron has a high durability against thermal deterioration and is effective in terms of the heat resisting property. Therefore, the inventors of the present invention estimated that it can be expected that also manganese and cobalt which indicate similar properties to iron have a heat resisting property.

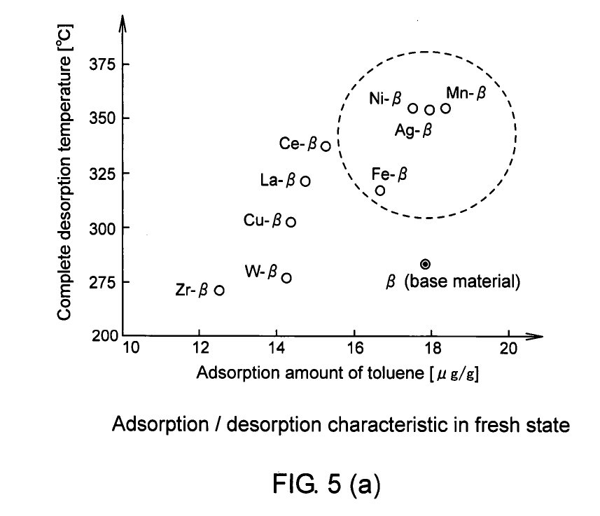

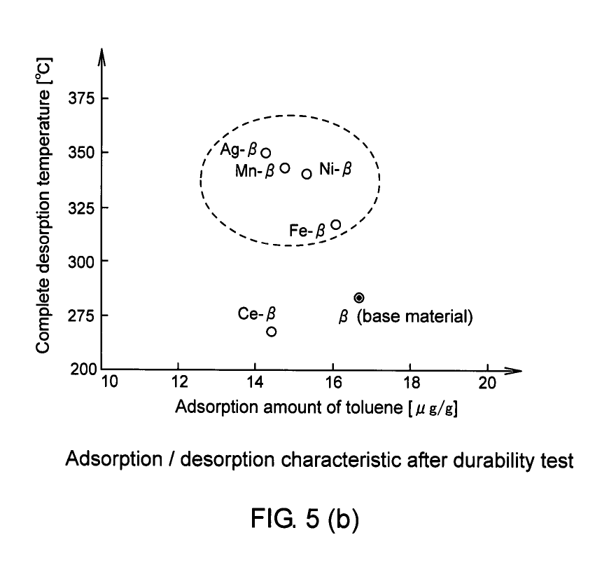

FIG. 5(a) illustrates results of an experiment of the adsorption/desorption characteristic of HC where various transition metals are contained in zeolite beta. Particularly, in FIG. 5(a), characteristics where the HC to be adsorbed is toluene are illustrated. In FIG. 5(a), as the position on the graph moves rightwardly on the graph, the adsorption amount of toluene increases, and as the position on the graph moves upwardly, the complete desorption temperature increases. In other words, as the position on the graph moves rightwardly upwards, the oxidation accelerating property increases.

Meanwhile, FIG. 5(b) illustrates results of another experiment of the adsorption/desorption characteristic of HC confirmed again after the specimens used in the experiment illustrated in FIG. 5(a) were subjected to a hydrothermal process at 750° C. for 10 hours. The performance of the specimens after the thermal deterioration generally exhibits a drop, and particularly the adsorption amount of toluene exhibits decrease with regard to all specimens. However, it can be seen that the decrease amount in the desorption amount of toluene is small with regard to the zeolite beta which contains iron.

[Preparation of the HC Trap Catalyst]

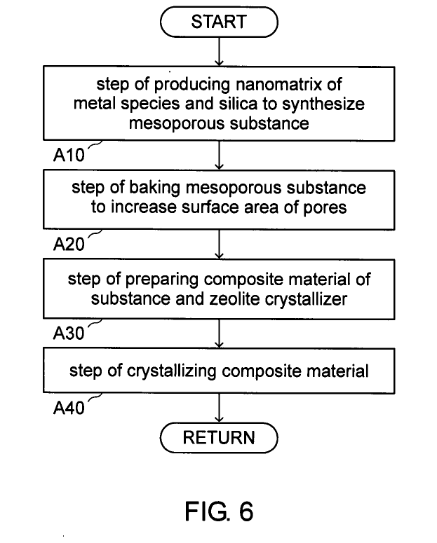

A preparation method for the zeolite beta which is used to form the HC adsorbent layer 3 of the HC trap catalyst 6 according to the present invention is described in detail. The zeolite beta is synthesized by a procedure illustrated in FIG. 6 using solid phase synthesis (dry gel conversion method). It is to be noted that the solid phase synthesis is a preparation method wherein dry gel obtained by drying raw material mixture for zeolite synthesis is processed with an organic structure regulating substance (organic template, SDA: Structure-Directing Agent) so as to be crystallized into zeolite. The organic structure regulating substance used in the preparation method may be any of various known organic compounds which contain nitrogen (N) or phosphorus (P) and may typically be a volatile organic amine or an ammonium compound.

Referring to FIG. 6, first at step A10 (step of producing nanomatrix of a metal species and silica to synthesize a mesoporous substance), silicon dioxide, alumina, a metal species (metal oxide), cetyltrimethylammonium bromide (tetra methyl ammonium bromide), tetra methyl ammonium hydroxide and water are mixed at a mixture ratio indicated by the following expression 1 to prepare mixed solution:
—SiO₂:Al₂O₃:MeOₓ:C₁₆TMABr:TMAOH:H₂O=1:0.01:0.02:0.61:0.5:60 (expression 1)

Then, the mixed solution is agitated at room temperature for two hours, and then, after the mixed solution is left at rest at 100° C. for three days, precipitates are filtered and sampled. Then, the precipitates are washed with ion-exchanged water and then dried at a room temperature. By the process, a mesoporous substance is levigated and synthesized.

At step A20 (step of baking the mesoporous substance to increase the surface area of the porous substance), the hydrogel filtered at the preceding step is subjected to a heating process at 540° C. for 12 hours to obtain Me—Al-MCM-41. The Me—Al-MCM-41 obtained here is in a porous state and has a great surface area.

At step A30 (step of preparing a composite material of the substance obtained by the second step and a zeolite crystallizer), 0.1 g of the Me—Al-MCM-41 obtained at the preceding step is mixed into 0.3 g of tetra ethyl ammonium hydroxide solution (TEAOH; 35 wt %) to produce a composite material. This is a precursor to the zeolite beta according to the present invention.

Then at step A40 (step of crystallizing the composite material), the mixture obtained at the preceding step is dried at a room temperature for 12 hours and then left at rest at 150° C. for 7 days. The inventors of the present invention successfully obtained zeolite beta of a mesoporous structure which contains iron in the skeleton thereof and has a high degree of crystallization.

[Confirmation of the Pore Diameter of the Obtained Zeolite Beta]

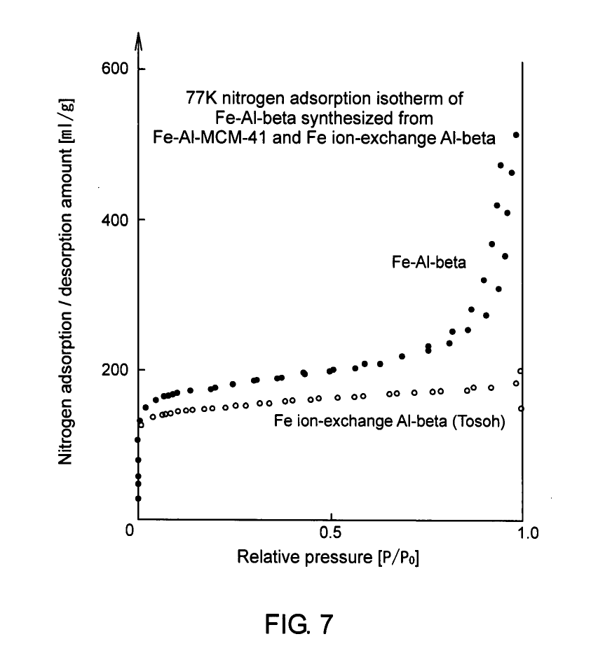

A nitrogen adsorption/desorption isotherm of the zeolite beta obtained through the procedure described above is plotted in dark spots in FIG. 7. It is to be noted that blank dots plotted in FIG. 7 represent a nitrogen adsorption/desorption isotherm of Fe/Al-beta (Si/2Al=39, by Tosoh Corp.) for reference which supports iron on zeolite beta placed on the market by ion exchange.

As seen in FIG. 7, the present zeolite beta exhibits a rise of the adsorption amount at a portion of the graph at which the relative pressure is low. This is a variation shape of the I type in the classification of IUPAC. In other words, it can be confirmed that micropores exist.

Further, at a portion of the graph at which the relative pressure is high, the adsorption amount of the present zeolite beta exhibits a great increase when compared with that of Fe/Al-beta. This is a variation shape of the IV type in the classification of IUPAC (International Union of Pure and Applied Chemistry). In other words, it can be estimated that mesopores and micropores exist in the present zeolite beta.

On the other hand, Fe/Al-beta does not exhibit an increase of the adsorption amount at a portion of the graph where the relative pressure is high, and mesopores or micropores are not confirmed.

It is to be noted that, at a portion of the graph where the relative pressure is high, the isotherm upon measurement of the adsorption and the isotherm upon measurement of the desorption do not coincide with each other. In other words, a hysteresis is exhibited. From this, it can be recognized that mesopores existing in the present zeolite beta have some distribution width. In other words, the pore width is not uniform.

[Effect 1: Partial Oxidation]

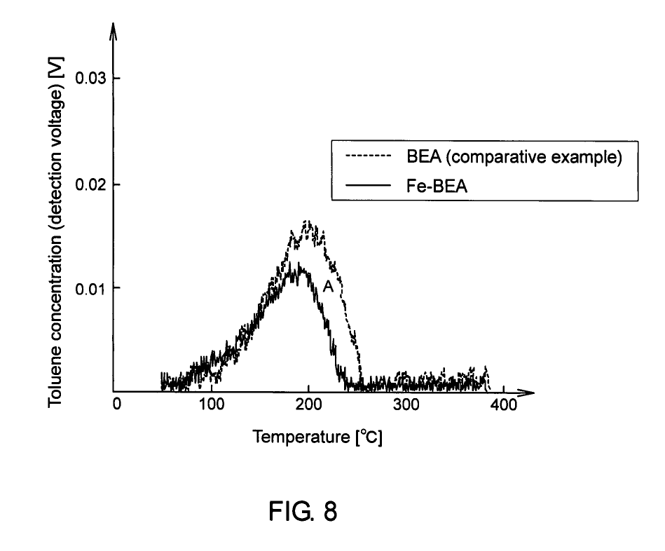

Details of the partial oxidation performance analysis by the present HC trap catalyst 6 are illustrated in FIG. 8.

Here, exhaust gas (50 ml/min) exhausted from the engine 9 was used as the carrier gas and 0.1 g of the catalyst (Fe-BEA+5% Pt—Al₂O₃) which composes the HC adsorbent layer 3 of the HC trap catalyst 6 was used as a sample, and in these conditions, the concentration of toluene was measured using a flame ionization detector (FID). The rate of temperature rise of the exhaust gas was 20° C./min, and a result of the measurement is represented by a graph of a solid line in FIG. 8. It is to be noted that the graph indicated by a broken line in FIG. 8 is an object of comparison. The object of comparison indicates the concentration of toluene where zeolite beta which does not contain iron [HSZ-940HOA (by Tosoh Corp.)+5% Pt—Al₂O₃, 1:1] is sampled.

As seen in FIG. 8, it can be recognized that, with the present HC trap catalyst 6, the concentration of toluene can be reduced by a great amount over a great temperature range. This is because the region A surrounded by the solid line and the broken line in FIG. 8 indicates the concentration of toluene which decreases as a result of acceleration of partial oxidation of toluene.

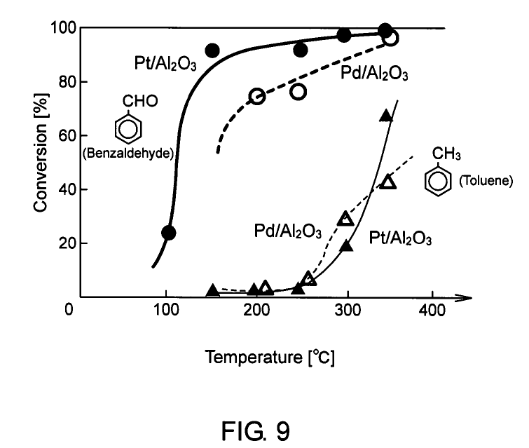

Further, results of an analysis of the HC decomposing power provided by partial oxidation of HC are illustrated in FIG. 9.

Here, the decomposing power (conversion) for toluene and the decomposition performance for benzaldehyde are indicated where platinum (Pt—Al₂O₃) and palladium (Pd—Al₂O₃) are used as the catalyst which composes the oxidation catalyst material layer 5 of the present HC trap catalyst 6. It is to be noted that benzaldehyde is one of substances obtained by partially oxidizing toluene.

As seen in FIG. 9, it can be recognized that benzaldehyde exhibits very high oxidation reactivity on the oxidation catalyst material layer 5 when compared with toluene. In particular, since HC partially oxidized on the HC adsorbent layer 3 contains oxygen in the molecular structure thereof, it is more likely to oxidize than the HC before it is partially oxidized and can burn at a low temperature. Further, if the temperature condition of the oxidation catalyst material layer 5 is same, then the partially oxidized HC can burn more than HC which is not in a partially oxidized state.

[Effect 2: Cracking]

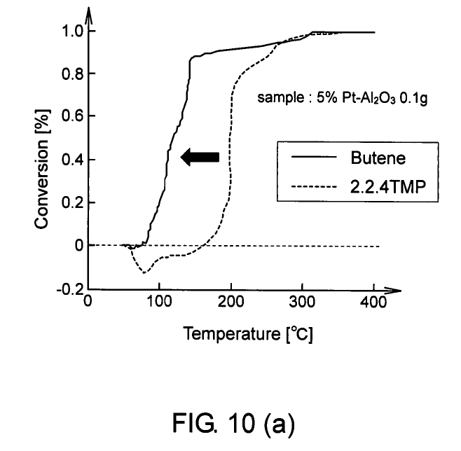

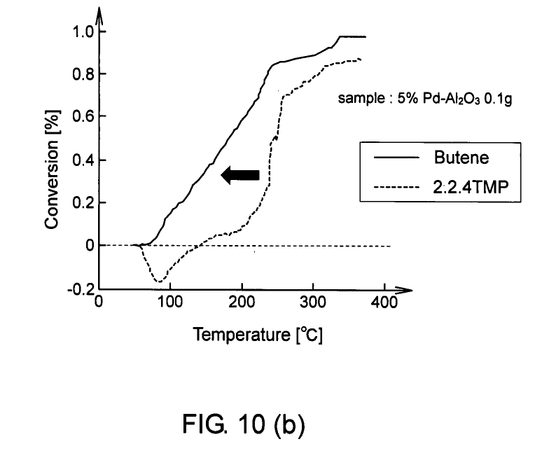

As described above, with the present HC trap catalyst 6, cracking occurs with adsorbed HC by an action of a transition metal contained in the HC adsorbent layer 3. Results of an analysis of change of the ignition temperature by cracking are illustrated in FIGS. 10(a) and 10(b).

In FIG. 10(a), exhaust gas (50 ml/min) exhausted from the engine 9 was used as the carrier gas and 0.1 g of the catalyst (5% Pt—Al₂O₃) which composes the oxidation catalyst material layer 5 of the present HC trap catalyst 6 was used as a sample, and in these conditions, the conversion (oxidation amount) of butene (C₄H₈) was measured using a flame ionization detector (FID). The conversion signifies the ratio of the oxidized mass to the original mass.

The rate of temperature rise of the exhaust gas was 20° C./min, and a result of the measurement is represented by a graph of a solid line in FIG. 10(a). The graph indicated by a broken line in FIG. 10(a) is an object of comparison. The object of comparison indicates the oxidation amount of isooctane (2.2.4-TMP). It is to be noted that butene is one of substances obtained from cracked isooctane.

As seen in FIG. 10(a), it can be recognized that, when compared with isooctane, butene exhibits a very high oxidation reactivity on the oxidation catalyst material layer 5. In particular, since HC cracked on the HC adsorbent layer 3 lost its molecular weight and is placed in a low-molecular state, it is likely to oxidize at a lower temperature than that of the HC before it is cracked and can burn at a lower temperature. Further, if the temperature condition of the oxidation catalyst material layer 5 is same, then the cracked HC can burn more than HC which is not in a cracked state.

Meanwhile, FIG. 10(b) illustrates results of the measurement where, among the analysis conditions illustrated in FIG. 10(a), the catalyst which composes the oxidation catalyst material layer 5 is changed from platinum to palladium (5% Pd—Al₂O₃). Also in FIG. 10(b), it can be recognized that, when compared with isooctane, butene exhibits very high oxidation reactivity on the oxidation catalyst material layer 5. In other words, it can be considered that cracked HC contributes to high combustion efficiency irrespective of the type of the catalyst.

[Effect 3: Adsorption/Desorption Performance]

As described hereinabove, the zeolite beta which composes the HC adsorbent layer 3 has not only micropores but also mesopores in the molecular structure thereof. Consequently, the zeolite beta can hold adsorbed HC in the mesopores and suppress the diffusion of the adsorbed HC. In other words, the HC trap catalyst 6 by itself can secure the reaction time for partial oxidation of adsorbed HC. The HC trap catalyst 6 has an advantageous construction to gain the reaction time.

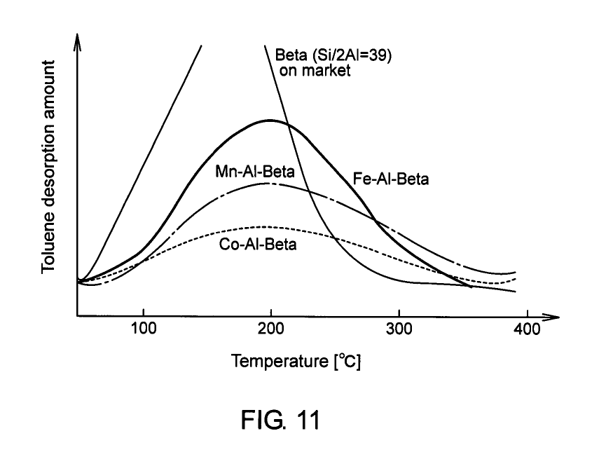

Details of such desorption preventing power analysis of HC as described above are illustrated in FIG. 11.

Regarding the desorption amount of toluene as an example of HC, three types of the zeolite beta according to the present embodiment and a zeolite beta [Beta (Si/2Al=39)] on the market are compared with each other. As seen in FIG. 11, when compared with the zeolite beta on the market, with the three zeolite beta according to the present embodiment, the toluene desorption spectrum is broad and the desorption amount of toluene is suppressed low over a wide temperature range. In this manner, it can be recognized that the zeolite beta according to the present embodiment has a higher adsorption performance for HC than the zeolite beta on the market which does not have mesopores. It is to be noted that such an HC adsorption performance as just mentioned is estimated to be further promoted by the composite structure of the micropore structure and mesopore structure which the zeolite beta has.

[Description of Modifications]

While an embodiment of the present invention is described above, the present invention is not limited to such an embodiment as described above, but can be carried out in various modified forms without departing from the spirit and scope of the present invention.

[Preparation by the Ion Exchange Method]

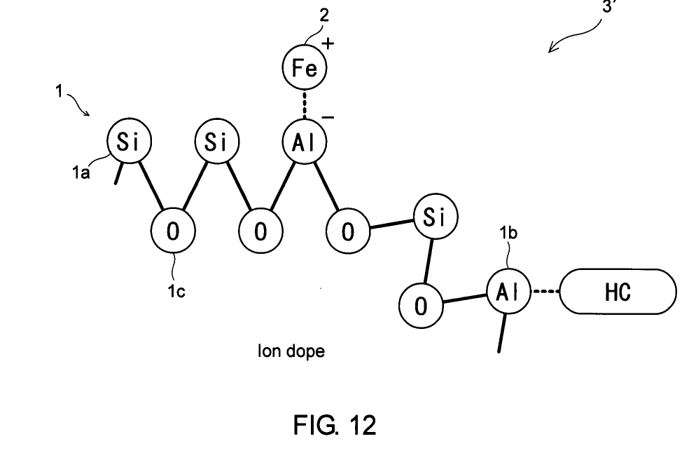

For example, it is a possible idea to prepare zeolite beta using a known ion exchange method in place of the solid phase synthesis. In this instance, the zeolite beta has such a molecular structure as seen in FIG. 12 wherein a transition metal (in FIG. 12, iron Fe) 2′ is contained in an ionized form in the zeolite beta 1. In other words, the transition metal 2′ is contained in a cation exchange site in the molecular structure of the zeolite beta. Also in such a molecular structure as just described, partial oxidation of adsorbed HC is accelerated, and cracking of the adsorbed HC can be promoted.

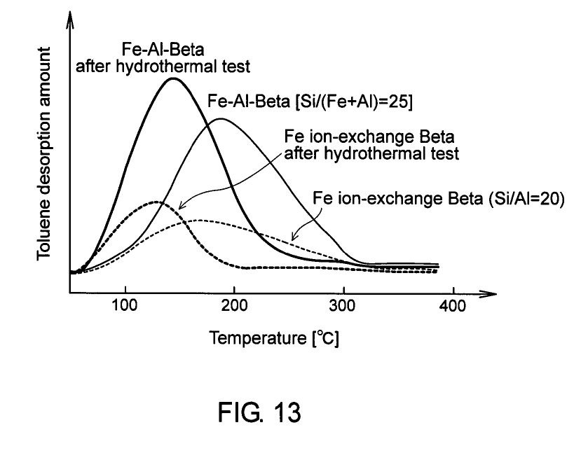

It is to be noted that an example of an experiment for comparison between the zeolite beta obtained by the solid phase synthesis described hereinabove and zeolite beta obtained by the ion exchange method is illustrated in FIG. 13. Here, a result of measurement of the desorption amount of toluene as an example of HC is illustrated with regard to each of the zeolite betas. Also results of an experiment of the desorption characteristic of HC confirmed again after a hydrothermal process (H₂O/air circulation) of the zeolite betas at 800° C. for five hours are illustrated.

From FIG. 13, it can be recognized that the zeolite beta obtained by the solid phase synthesis has a greater toluene adsorption capacity (and desorption capacity) than the zeolite beta obtained by the ion exchange method. Further, the zeolite betas have a similar tendency of the variation (thermal deterioration) of the behavior by the hydrothermal process. From this, it can be considered that, in regard to the adsorptivity of HC, the zeolite beta obtained by the solid phase synthesisis superior. Further, it is estimated that, within a range permitted by the adsorbing performance of HC, there is a room for investigation also in use of the zeolite beta obtained by the ion exchange method.

[Preparation from Other than the Zeolite Beta]

Also it may be possible to form the HC adsorbent layer 3 from zeolite other than zeolite beta. For example, FAU, MFI, MOR or FER may possibly be used.

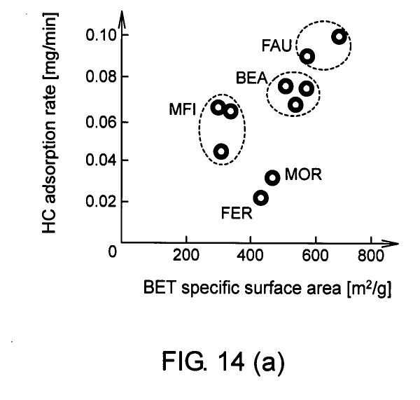

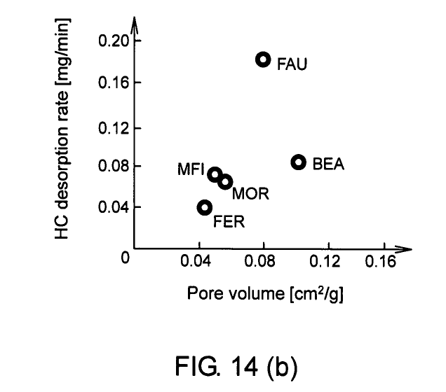

It is to be noted that FIGS. 14(a) and 14(b) illustrate the HC adsorption performance and desorption performance of various types of zeolite. In FIG. 14(a), the axis of abscissa indicates the BET specific surface area [measured by use of BET (Brunauer, Emmett and Teller) equation] and the axis of ordinate indicates the rate of HC, and the HC adsorbing performance of various types of zeolite is plotted. As regards the catalyst performance, a type of zeolite having a great specific surface area and a high HC adsorption rate is preferably used, and a material which is positioned on the right upper side on the graph is comparatively superior as an HC trap catalyst. In short, FAU, zeolite beta (BEA) and MFI are comparatively superior.

Meanwhile, in FIG. 14(b), the axis of abscissa indicates the pore volume and the axis of ordinate indicates the desorption rate, and the HC desorbing performance of various types of zeolite is plotted. As regards the catalyst performance, a type of zeolite having a great pore volume and a low desorption rate of HC is preferably used, and a material which is positioned on the right lower side on the graph is comparatively superior as an HC trap catalyst. From such a point of view as just described, it can be recognized that zeolite beta (BEA) is superior.

[Others]

Further, while the oxidation catalyst material layer 5 in the HC trap catalyst 6 is provided as an upper layer of the HC adsorbent layer 3 in the embodiment described hereinabove, also it is possible to adopt an alternative configuration wherein the oxidation catalyst material layer 5 is separated from the present HC trap catalyst 6. In this instance, an oxidation catalyst may be provided on the downstream side of the HC trap catalyst 6 on the exhaust path 8.

Or, also it is a possible idea to form the HC adsorbent layer 3 and the oxidation catalyst material layer 5 integrally with each other without separating them into layers. In this instance, both the zeolite beta 1 described above and a noble metal such as platinum may be supported on a surface of the carrier 4.

In the embodiment described above, it is described that zeolite which contains iron, manganese or cobalt is effective in the phase of the heat resisting property. However, according to the present invention, the element to be contained in the zeolite beta is not limited to them. In particular, any element is considered to exhibit such effects as described above only if at least it is active on oxidation of HC. In other words, any transition metal may be used.

Further, while, in the embodiment described hereinabove, the molecular structure of zeolite beta has not only micropores but also mesopores formed therein, the structure of the HC trap catalyst of the present invention is not limited to the specific structure. In other words, a material having uniform mesopores other than mesoporous silica (MCM-41, MCM-48, SBA-3, SBA-15, SBA-16 and so forth) may be used to produce zeolite beta which contains a transition metal element. In this instance, although the desorption suppressing effect of HC by mesopores cannot be anticipated, it is considered that, if zeolite beta is used, then enhancement of the HC adsorption performance by the beta structure thereof can be expected.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An HC trap catalyst, comprising:
an HC adsorbent for adsorbing HC in exhaust gas exhausted from an internal combustion engine; and
an oxidation accelerating element contained in said HC adsorbent for accelerating partial oxidation of the HC adsorbed by said HC adsorbent.

2. An HC trap catalyst as claimed in claim 1, wherein said HC adsorbent comprises zeolite which is a crystalline porous body having a three-dimensional network structure.

3. An HC trap catalyst as claimed in claim 2, wherein said HC adsorbent comprises zeolite beta.

4. An HC trap catalyst as claimed in claim 2, wherein said HC adsorbent has mesopores.

5. An HC trap catalyst as claimed in claim 2, wherein said oxidation accelerating element includes a transition metal element.

6. An HC trap catalyst as claimed in claim 2, wherein said oxidation accelerating element includes at least one metal element selected from Fe, Mn and Co.

7. An HC trap catalyst as claimed in claim 2, wherein said oxidation accelerating element is arranged in a skeleton of the zeolite in a substituted relationship for Si or Al which forms the zeolite.

8. An HC trap catalyst as claimed in claim 2, wherein said oxidation accelerating element is contained in a cation exchanging site in the three-dimensional network structure of the zeolite.

9. An HC trap catalyst as claimed in claim 1, further comprising
an oxidation catalyst material containing a noble metal for burning the HC partially oxidized by said oxidation accelerating element.

10. A preparation method for an HC trap catalyst which utilizes a solid phase method of an HC trap catalyst interposed in an exhaust path of an internal combustion engine, comprising:
a first step of producing nanomatrix of a metal species and silica to synthesize a mesoporous substance;
a second step of baking the mesoporous substance synthesized by the first step to increase the surface area of the porous substance;
a third step of preparing a composite material of the substance obtained by the second step and a zeolite crystallizer; and
a fourth step of crystallizing the composite material prepared by the third step.
